(19) United States
(12) Patent Application Publication
(10) Pub. No.: US 2010/0314156 A1
(43) Pub. Date: Dec. 16, 2010

(54) AU ALLOY WIRE FOR BALL BONDING

(75) Inventors: Mitsuo Takada, Saga-ken (JP); Satoshi Teshima, Saga-ken (JP); Takeshi Kuwahara, Saga-ken (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TANAKA DENSHI KOGYO K. K., Tokyo (JP)

(21) Appl. No.: 12/740,578

(22) PCT Filed: Oct. 15, 2008
(86) PCT No.: PCT/JP2008/068677

§ 371 Date: Apr. 29, 2010

(30) Foreign Application Priority Data
Nov. 6, 2007 (JP) 2007-288800

(51) Int. Cl. H01B 5/00

(52) U.S. Cl. 174/126.1

(57) ABSTRACT

[Issues to be Solved] To provide Au alloy wire for ball bonding, which is superior in wire strength, and also is superior in formability of molten ball and roundness of compressed ball. Moreover it is superior at stitch bondability, and is available for high density wiring of semiconductor devices.

[Solution Means] An Au alloy wire for ball bonding comprising: 15-50 wt ppm Mg, 10-30 wt ppm Ca, 5-20 wt ppm Eu, 5-20 wt ppm Y, 5-20 wt ppm La and residual Au is 99.998 wt % purity or higher, moreover, purity of more than 99.98 wt % Au. The mass of additive Ca is less than the value of total amount of additive Eu and additive La, and the mass of additive Y is less than the value of the total amount of additive Ca and additive Eu, and the mass of Mg is 20-40 wt ppm.

This application is based on International Application No. PCT/JP2008/68677, Filed on Oct. 15, 2008 (Which has the following Priority Data: Japanese Patent Application No. 2007-288800, filed on Nov. 6, 2007), the entire contents of which are incorporated herein by reference.

### FIELD OF THE INVENTION

The present invention relates to Au alloy wire for ball bonding, which is superior at fracture load of tensile test at 4% elongation (described as wire strength hereinafter), has less contamination of oxides at the surface of the molten ball, has fewer shrinkage cavities during formation of the molten ball, is superior at stability of ball shape by melting (described as formability of molten ball hereinafter), is superior at roundness of compressed ball shape when molten ball is bonded (described as roundness of compressed ball shape hereinafter), and is superior at stitch bondability when the wire is bonded wire compressed to frame and/or substrate through capillary (described as stitch bondability hereinafter).

### STATE OF THE ART

In the case of bonding with an electrode of an IC chip and outer lead, wire-bonding methods wired through a wire are known. Among these methods as a manner of bonding with Al electrodes of an IC chip, thermo-compression and thermo-sonic bonding are in the mainstream. In thermo-sonic bonding, ball-bonding method is conventionally used. The Bonding method by ball bonding is explained using the figure illustrated in Reference Patent 1 (Japanese Patent Application No. 3657087) shown hereinafter. As shown in the FIG. 1(a), wire 2 is sent from a thin hole of the tip of a capillary through a wire hole of capillary 1, an electric torch 3 is set against the tip discharging between wire 2, heating and melting the tip of wire 2 takes place and ball 4 is formed. Then as shown in the FIG. 1(b), capillary 1 is taken downward and said ball 4 is compressed bonded to Al electrode 5 on the IC chip 6. Where, it is not illustrated here, ultrasonic vibration through capillary 1 is applied and since IC chip 6 is heated at heat block, said ball 4 compressed bonded becomes compressed ball 4′. Then as shown in the FIG. 1(c), capillary 1 tracing a defined locus, moves to above the outer circuit wire 8 of lead frame, and it goes down. Then, it is not illustrated here, ultrasonic vibration through capillary 1 is applied, since the outer circuit wire 8 is heated at heat block, side wall of wire 2 is thermal compressed and bonded (known as stitch bonding). Then, as shown in FIG. 1(d), clamper 7 goes upward with keeping clamped wire 2 and wire 2 is cut, so wiring is finished.

In general, an Au alloy wire for ball bonding should have wire strength, formability of molten ball, roundness of compressed ball shape and stitch bondability in practical use. Moreover, elongation rate of conventional ball bonding wire is set at 2-6%, it is preferably more than 3% of elongation rate considering formability of loop, and especially 4% is known as most preferable.

On the other hand, in Reference Patent 1, Au alloy wire for wedge bonding had been developed comprising: 1-100 wt ppm of additive Ca to high purity Au, which Au purity of said Au alloy wire is more than 99.9 wt %, tensile strength is more than 33.0 kg/mm², and elongation rate is 1-3%. This Au alloy wire is superior at high temperature tensile strength, and is suitable for high density wiring for IC chip, and had been used by wedge bonding. A portion of bonding by wedge bonding, shown in FIG. 2(b), has a feature of compressed width of wire which can be controlled within 1.5-2.5 times of wire diameter.

However, when this Au alloy wire is applied to ball bonding, it can't be used for stable ball bonding because of poor roundness of compressed ball shape. Moreover, since the elongation rate is lower, it is hard to draw a loop shape, and it becomes worse at formability of loop. Hence, the usage is limited to wedge bonding, and range of semiconductor devices as object had been limited.

[Reference Patent 1] JP 3657087

[Reference Patent 2] JPA 1998-4114

### DISCLOSURE OF INVENTION

### Problems to be Solved by the Invention

The present invention aims to provide Au alloy wire, in view of the past's above-mentioned circumstances, which is the same as conventional Au alloy wire for wedge bonding wire, and is superior at pull strength, and is superior at formability of molten ball and roundness of compressed ball, moreover it is superior at stitch bondability suitable for high density wiring semiconductor device.

### Means to Solve the Problems

The inventors of the present invention had made every effort and investigated Au alloy wires for superior at strength. Consequently if the mass of additive Ca is less than the value of the total amount of Y, Eu and La, and the mass of the additive Y is less than the value of the total amount of Eu and La, it has been discovered that Au alloy comprising trace additive of Ca-Mg-Eu-La-Y has superior effect of wire strength, formability of molten ball, roundness of compressed ball shape, and stitch bondability, and the present invention has been accomplished.

Concretely, according to the present invention, Au alloy wire for ball bonding comprising: 15-50 wt ppm Mg, 5-20 wt ppm Eu, 5-20 wt ppm La, 5-20 wt ppm Y, 10-30 wt ppm Ca, and the residual Au, is provided.

Moreover, according to the present invention, Au alloy wire for ball bonding comprising: 15-50 wt ppm Mg, 5-20 wt ppm Eu, 5-20 wt ppm La, 5-20 wt ppm Y, 10-30 wt ppm Ca, and the residual Au, and mass of additive Ca is less than the value of total amount of additive Eu and additive La, and mass of additive Y is less than the value of total amount of additive Ca and additive Eu, and mass of 20-40 wt ppm Mg, is provided.

Moreover, according to the present invention, Au alloy wire for ball bonding comprising: 15-50 wt ppm Mg, 5-20 wt ppm Eu, 5-20 wt ppm La, 5-20 wt ppm Y, 10-30 wt ppm Ca, with the residual Au, and mass of additive Ca is less than the value of total amount of additive Eu and additive La, and mass of additive Y is less than the value of total amount of additive Ca and additive Eu, is provided.

In a preferable embodiment, trace additive of 20-40 wt ppm Mg is added.

And in a preferable embodiment, Au alloy wire for ball bonding is used having a purity of 99.98 wt % Au or higher.

In a more preferable embodiment, Au alloy wire for ball bonding is used having a purity of 99.99 wt % Au or higher.

### EFFECTS OF THE PRESENT INVENTION

Au alloy wire for ball bonding of the present invention has superior effect of wire strength, stitch bondability, formability of molten ball and roundness of compressed ball shape as Au alloy comprises a prescribed composition of trace additives of Ca-Mg-Eu-La-Y. Especially, it has characteristics of attaining wire strength, stitch bondability, and roundness of compressed ball shape at the same time.

### DESCRIPTION OF MOST PREFERRED EMBODIMENT

In the present invention, the variety of additive elements is less and the range of components is narrow and definitive. Losing balance of composition ratio of additive elements of the present invention, it may have a bad influence upon wire strength, stitch bondability, formability of molten ball and roundness of compressed ball shape, so purity of Au is preferable to be as high as possible. Moreover, in the system of the present invention, it is commercially advantageous, since it is available to display as high purity bonding wire 99.99 wt % or more, if the total amount of trace additive elements except Au and impurity elements is less than 100 wt ppm.

### (Stitch Bondability and Wire Strength)

Stitch bonding of bonding wire is classified into solid-phase bonding. Easiness of deformation to form stitched portion and higher strength of bond at stitch portion are known phenomena, which have significant impact upon solid-phase bonding. Easiness of deformation to form stitched portion means that deformation by elastic deformation, plastic deformation, creep deformation and diffusion is easy to occur. This phenomenon is the same as with stitch bonding, in the case of bonding wire, hence it is considered that the lower strength of wire is easier deformation for forming stitched portion, so there is a negative correlation between wire strength and stitch bondability. On the other hand, connected strength at stitched portion is caused by various phenomena such as chemical bond strength, adhesion, surface roughness, surface condition and so on. However, conventional Au alloy wire for ball bonding has originally stronger bonding strength than other metallic bonding wire has. This is because of composition of Au, which purity is 99 wt %-99.99 wt %, and it almost does not oxidize in the air. Therefore, it is considered that the lesser ill effect of additive elements and its oxide exist at the surface of the bonding wire, the stronger strength of stitch bonding portion can be gotten.

When ball bonding Au wire is made using purity of 99.999 wt % or more without any additive element, it may have an advantage of easiness to deformation to form a stitch portion because the wire is soft, there is no ill effect of additive elements and its oxide on the surface of wire, so it is considered that it may be the best bonding wire at superior stitch bondability. However, it is required to have plural functions to bonding wire at the same time, for example, if wire strength is not stronger than some level of strength, problems occur in practical use such as poor wire flow at plastic molding and poor loop formability. Consequently, in order to enhance wire strength, it is necessary to use trace additive elements. All trace additive elements of the present invention relate to effect of bonding strength at stitched portion and they are not apt to interfere with stitch bondability comparing with pure Au. Moreover, using prescribed composition ratio of trace additive elements of the present invention has also an effect to enhance wire strength. Where, it is considered that existence of oxide of additive elements on the surface of the wire is caused to annealing at a temperature of about 30%-60% of melting point after final drawing. It may be thought that it could be possible to decrease oxides by annealing in inert gas atmosphere and by chemical cleaning of wire surface after annealing, but there is a problem from the aspect of manufacturing cost, the method of the present invention is more practical.

### (Formability of Molten Ball)

Molten ball means that a ball formed by melting the tip of the bonding wire by a spark discharging in the air. The more volume of the additive elements, oxide of additive elements are observed at the whole surface of the ball and at a boundary of the wire (so called neck). Moreover, in some cases, shrinkage cavities are generated at the bottom of the ball. On performance of bonding wire, formability of molten ball is important, and it is required that oxide and shrinkage cavities should be as reduced possible. Molten ball formability, which meets these industrial requirements in practical use is obtained by using prescribed composition ratio of trace additive elements of the present invention.

### (Roundness of Compressed Ball)

The space and area of Al electrodes on an IC chip have become narrower and smaller by higher density implementation of semiconductor devices. When bonding on a narrower and smaller Al electrode, it is necessary and inevitable to improve roundness of compressed ball in order to avoid contact with a neighboring compressed ball. Composition ratio of additive elements has great effect to roundness of compressed ball; losing the balance of composition ratio, deformation of molten ball become heterogeneous at compressed bonding, and compressed ball shape can not be maintained with its roundness. Moreover, roundness of compressed ball has a tendency of a negative correlation with wire strength as same as stitch bondability. Compatibility of roundness of compressed ball with wire strength for practical use can be attainable using prescribed composition ratio of trace additive elements of the present invention.

### [Mg]

Mg in the alloy system of the present invention is the most effective element for roundness of compressed ball.

Mg in the alloy system of the present invention as an additive element does not have enough effect to wire strength. In the alloy system of the present invention, Mg is necessary to be greater than 15 wt ppm, because, less than this, there is no effect to roundness of the compressed ball. In the alloy system of the present invention, in order to have a stable roundness of the compressed ball, Mg is preferably over 20 wt ppm. On the other hand, in the alloy system of the present invention, in the case of exceeding more than 50 wt ppm Mg, stability of ball shape formed by melting (described as formability of molten ball hereinafter) has mischief. In the alloy system of the present invention, less than 40 wt ppm Mg is preferable in order to keep good formability of molten ball.

### [Eu] and [La]

In the alloy system of the present invention, though Eu and La are effective elements for wire strength of bonding wire, they have no effect like Ca described hereinafter. Moreover, in the alloy system of the present invention, though Eu and La are effective elements to roundness of the compressed ball shape, they have no effect like Mg. In the alloy system of the present invention, Eu and La are necessary to be greater than 5 wt ppm, because, less than this, there is no effect to roundness of the compressed ball and wire strength. On the other hand, in the alloy system of the present invention, in the case of exceeding more than 20 wt ppm, they have mischief on formability of molten ball.

### [Ca]

In the alloy system of the present invention, Ca is the most effective element for wire strength. However, Ca has mischief on roundness of the compressed ball. Hence, in the alloy system of the present invention, effective composition range of Ca is definitive to such very narrow range like 10-30 wt ppm. Only within the range, Ca has such effect in the alloy system of the present invention. Because, in the alloy system of the present invention, less than 10 wt ppm Ca has no effect to wire strength, in the case of over than 30 wt ppm Ca, it has mischief on roundness of the compressed ball.

### [Y]

In the alloy system of the present invention, Y is an effective trace additive element for wire strength. However, in the alloy system of the present invention, Y as well as Ca is an element which has mischief on roundness of the compressed ball. Y is an optional additive element in the alloy system of the present invention, it is necessary to be greater than 5 wt ppm Y in order to have the above mentioned effect. If it is less than this, it is the same as the case of no additive of Y. On the other hand, in the alloy system of the present invention, in the case of exceeding more than 20 wt ppm Y, it has mischief on roundness of the compressed ball.

### [Eu+La+Ca]

In the alloy system of the present invention, it is considered that Eu and La have an interaction with Ca. Namely, all of Eu, La and Ca are effective additive elements, and there is synergy to enhance the wire strength by co-addition of these trace additive elements.

[Ca] is equal to or less than ([Eu]+[La])

In the alloy system of the present invention, though Ca is an additive element, which has a harmful effect to roundness of the compressed ball shape, it is possible to reduce considerably such mischief of adding Ca to Au by co-addition of Eu and La. It is considered that by co-addition of Eu and La, each element may have such function like a shock absorber material, and mischief to roundness of the compressed ball by Ca is reduced compared with single addition of it.

[Y] is equal to or less than ([Ca]+[Eu])

Y shows similar effect of addition like Ca, but it is an element, which has harmful effect to roundness of the compressed ball diameter greater than Ca. Especially, in the case when the volume of additive Y is more than the value of the co-addition volume of Ca and Eu, it appears that strong mischief of roundness of the compressed ball shape is caused. However, with the co-addition of Ca and Eu, each element has a shock absorber effect, and there is an effect of reducing mischief of roundness of the compressed ball shape by Y. Hence, volume of additive Y is necessary to be less than the volume of the total additional amount of Ca and Eu.

### (1) Wire Strength

On wire strength when adjusting elongation of 4%, Au alloy of the present invention had been evaluated using a measuring method that is the same as a conventional one. Measurement was done at room temperature, at 100 mm gauge length, and at 10 mm/min speed, and was calculated by using following equation from elongation as fracture. Judgment was done by calculating the mean value of 5 wires, which were conditioned at 4% elongation of 25μ meters diameter after final heat treatment. The high value of samples is shown as good. Concretely, it is shown as “Best” for more than 12.5 g (122.5 mN) of wire strength, as “Better” for the range of 12.5 g (122.5 mN)-11.5 g (112.7 mN) of wire strength, as “Good” for the range of 11.5 g (112.7 mN)-11.0 g (107.8 mN) of wire strength, and as “Bad” for range of less than 11.0 g (107.8 mN) of wire strength.

$$Elongation = \frac{Elongated length as fracture ( mm )}{100 ( mm )} \times 100 ( \% ) \qquad [ Equation 1 ]$$

### (2) Formability of Molten Ball

Formability of molten ball is possible to confirm easily by conventional scanning electron microscopy and optical microscopy.

In the present invention, judgment was done for the samples, which confirmed more than 6 pieces with whole surface contamination of oxide and/or shrinkage cavities by scanning electron microscopy, shown as “Bad” and for the samples, which confirmed between 3-5 pieces, shown as “Good”, and for the samples, which confirmed less than 2 pieces, shown as “Best”, among 10 wire samples.

### (3) Stitch Bondability

Stitch bonding means deforming the wire by applied load and ultrasonic through capillary, and bonding to an Ag, Au, and/or Pd plated frame or substrate. On stitch bondability, the Au alloy of the present invention can be kept at high level as same as a conventional Au alloy. The measurement method of the present invention is as follows: using electroless Au plated FR-4 resin substrate, is shown in the FIG. 3, as setting center of compressed ball as 0%, and as setting stitch bonding as 100%, measuring position is at 90% near at stitch bonding. Samples were measured just after bonding, IC chip side and resin substrate were fit by a jig, the sample wire was pulled upward, then peel strength was measured. Judgment was done by mean value of 30 samples, and the higher value of it was evaluated as good. Concretely, it was shown as “Best” for more than 6.0 g peel strength, shown as “Better” for 4.5 g-6.0 g peel strength, shown as “Good” for 3.0 g-4.5 g peel strength, and shown as “Bad” for less than 3.0 g peel strength.

### (4) Roundness of Compressed Ball

Evaluation of roundness of the compressed ball was done as follows:

Ball bonding was done at a condition that the compressed ball diameter is 63μ meters to Al electrode (thickness of Al: about 7×10⁻⁸ m) on Si chip, then stitch bonding was done between Au plated FR4 resin substrate, and was wired by ball bonding method. 200 samples were wired at the condition of the 3×10⁻³ m span. Roundness of the compressed ball was evaluated using 50 compressed balls random sampled within these wired wires.

Compressed diameters were measured for each direction, such as the applied direction of ultrasonic compressed ball, parallel direction of that and horizontal direction of that. Lower value of standard deviation from total 50 wired wires was judged as “Good”. Concretely, it was shown as “Best” for less than 0.8μ meters standard deviation, shown as “Better” for 0.8μ meters—1.2μ meters standard deviation, shown as “Good” for 1.2μ meters—1.5μ meters standard deviation, and shown as “Bad” for more than 1.5μ meters standard deviation.

### (5) Manufacturing Method of Au Alloy Wire

A preferable manufacturing method of Au alloy wire of the present invention is explained. It is casted into ingot after melting in the vacuum furnace adding the prescribed amount of elements into high purity Au. It is applied to cold metal forming using ditch roll and drawing mill to the said ingot, and intermediate annealing, and after getting thin wire which diameter is 25μ meters by final drawing, it is conditioned at 4% elongation by final annealing.

### [Effects]

Au wire, which purity is 99.999 wt % or more, has low wire strength and its wire strength is declined with the passage of time. Hence, Au alloy wire for bonding wire is stronger than 99.999 wt % purity Au by adding prescribed optional additive elements. In almost all bonding wire in the market are added some rare earth metals such as Be and Ca; these additive elements have the effect of strengthening the wire. On the other hand, stitch bondability required for bonding wire becomes worse when the stronger wire becomes harder to deform a contact portion described hereinbefore, and in order to strengthen the wire, bonding strength of contact portion becomes lower by increasing additive elements. In the present invention, strengthening by adding some kinds of additive elements, some additive elements, which have less mischief against bonding strength at bonded portion and do not make stitch bondability worse, are defined. It was found that Ca, Eu, La and Y are the most optimum additive elements, moreover, it was found that when adding these elements at once, the wire strength becomes higher.

When adding wire strength and stitch bondability, roundness of the compressed ball is also required to conventional bonding wire. However, in general, it is known that it is difficult to keep roundness of the compressed ball under the condition of higher wire strength. In the alloy system of the present invention, roundness of compressed ball is keeps its roundness by using Mg, which has less effect to wire strength.

However, though the Au alloy system used Ca, Eu, La and Y described hereinbefore, which has superior function at wire strength and stitch bondability, it was ascertained that roundness of the compressed ball can not be improved in the case of neglected use of interaction of other elements, which improve wire strength, and volume of adding. Hence, Ca in the alloy system of the present invention was compounded considering volume of adding and interaction with other additive elements, which have effect of enhancing wire strength, paying attention to composition ratio of Ca, Eu and La, consequently it was successful that it maintained effect of improving roundness of compressed ball and it had improved stitch bondability and wire strength at the same time. Concretely, Ca in the alloy system of the present invention is more effective to enhance wire strength of bonding wire than Eu and La. Then as Ca has an effect to wire strength of bonding wire, in order to set effect of Ca subordinated, and in order to set effect of Eu and La primarily, the mass of Ca is defined as less than the sum of Eu and La.

Moreover, Y in the alloy system of the present invention, was composed considering adding volume and interaction with other additive elements, which have a function of enhancing wire strength, consequently, paying attention to composition ratio of Ca and Eu, it was successful that stitch bondability and wire strength is improved at once, keeping the effect of improvement for roundness of the compressed ball. Concretely, Y in the alloy system of the present invention, is more effective for wire strength of bonding wire by adding Ca and Eu at once. However, if adding Y at more than the defined volume, it can not be maintained with roundness of the compressed ball; it is defined that the mass of Y should be less than the sum of Ca and Eu.

### [Evaluation 1]

Conventional examples, embodiment examples and comparative examples are explained shown in Table 1.

### Conventional Examples

As conventional example 2 is shown Example 38 in Reference Patent 1 (JP 3657087) and as conventional example 3 is shown Example 14 in Reference Patent 2 (JP H10-4114).

### Embodiment Examples and Comparative Examples

Au alloy ingot of composition in the left column of Table 1 was obtained by casting after melting in the vacuum furnace adding prescribed trace amount of elements into high purity of 99.999 wt % Au. Cold metal forming was applied to the said ingot using ditch roll and drawing mill, and intermediate annealing, after getting thin wire which diameter was 25μ meters by final drawing, it was conditioned at 4% elongation by final annealing.

In the embodiment example 1-11, volume of addition of additive elements were varied within the range of standard as described in claim 1, such as 15-50 wt ppm Mg, 10-30 wt Ca, 5-20 wt ppm Eu, 5-20 wt ppm Y and 5-20 wt ppm La.

On the contrary, in comparative example 1-10, volume of each additive element was varied slightly out of the range of standard.

### (Evaluation Method)

Au alloy wire was bonded to Al electrode on an IC chip compressing the ball and was stitch bonded to Au plated FR-4 resin substrate using the ball bonding equipment (UTC 1000 Type from Shinkawa Company Ltd.). The condition of IC chip side bonding was as follows: the load was 3.0×1.0×10⁻³N(30 gf), the bonding time was 12 msec, and the ultrasonic output power was 300 mW. On the other hand, bonding condition of FR-4 resin substrate was as follows: the load was 4.3×1.0×10⁻³N(43 gf), the bonding time was 12 msec, and the ultrasonic output power was 400 mW. Bonding temperature, as common bonding condition, considering low temperature bonding, was 140 degrees Celsius, the capillary of SBNS-33CD-AZM-1/16-XL from SPT Company Ltd. was used. Then using samples right after bonding, roundness of the compressed ball was measured from direction of upward of Al electrode, and stitch bondability was measured from wire peeling strength near at FR-4 resin substrate. Measurement results are shown in the right column in Table 1.

TABLE 1

| | | | Kinds of | | | | | | | | Result of measurement | | | |
|---|---|---|---|---|---|---|---|---|---|---|---|---|---|---|
| | | | additive elements | | | | | Volume of additive | | | | | | Roundness |
| | | | and its ratio | | | | | (wt ppm) | | | | | Formability | of |
| | | | (wt ppm) | | | | | Total | Ca < | Y < | Wire | Stitch | of | compressed |
| | | Au | Mg | Eu | La | Y | Ca | amount | Eu + La | Eu + Ca | strength | bondabiliy | molten ball | ball |
| Conventional | 1 | Residual | 25 | 10 | *0 | 11 | 25 | 71 | Out of range | OK | Good | Better | Better | Bad |
| exaples | 2 | Residual | 20 | *0 | 20 | *21 | 10 | 71 | OK | Out of | Good | Better | Better | Bad |
| | | | | | | | | | | range | | | | |
| | 3 | Residual | 29 | 8 | *0 | *0 | 10 | 47 | Out of range | OK | Bad | Better | Better | Bad |
| Embodiment | 1 | Residual | *18 | 13 | 13 | 13 | 20 | 77 | OK | OK | Better | Better | Better | Good |
| examples | 2 | Residual | 30 | 13 | 13 | 13 | 20 | 89 | OK | OK | Better | Better | Better | Better |
| | 3 | Residual | *47 | 13 | 13 | 13 | 20 | 106 | OK | OK | Better | Better | Good | Best |
| | 4 | Residual | 30 | 8 | 13 | 13 | 20 | 84 | OK | OK | Better | Better | Better | Better |
| | 5 | Residual | 30 | 18 | 13 | 13 | 20 | 94 | OK | OK | Better | Better | Better | Better |
| | 6 | Residual | 30 | 13 | 8 | 13 | 20 | 84 | OK | OK | Better | Better | Better | Better |
| | 7 | Residual | 30 | 13 | 18 | 13 | 20 | 94 | OK | OK | Better | Better | Better | Better |
| | 8 | Residual | 30 | 13 | 13 | 8 | 20 | 84 | OK | OK | Better | Better | Better | Best |
| | 9 | Residual | 30 | 13 | 13 | 18 | 20 | 94 | OK | OK | Better | Better | Good | Good |
| | 10 | Residual | 30 | 13 | 13 | 13 | 13 | 82 | OK | OK | Good | Best | Better | Better |
| | 11 | Residual | 30 | 13 | 13 | 13 | 25 | 94 | OK | OK | Better | Good | Good | Good |
| Comparative | 1 | Residual | *10 | 13 | 13 | 13 | 20 | 69 | OK | OK | Better | Better | Better | Bad |
| examples | 2 | Residual | *58 | 13 | 13 | 13 | 20 | 117 | OK | OK | Better | Better | Bad | Better |
| | 3 | Residual | 30 | *2 | 13 | 13 | 20 | 78 | Out of range | OK | Good | Better | Better | Bad |
| | 4 | Residual | 30 | *28 | 13 | 13 | 20 | 104 | OK | OK | Better | Better | Bad | Better |
| | 5 | Residual | 30 | 13 | *2 | 13 | 20 | 78 | Out of range | OK | Good | Better | Better | Bad |
| | 6 | Residual | 30 | 13 | *28 | 13 | 20 | 104 | OK | OK | Better | Better | Bad | Better |
| | 7 | Residual | 30 | 13 | 13 | *2 | 20 | 78 | OK | OK | Bad | Better | Better | Better |
| | 8 | Residual | 30 | 13 | 13 | *28 | 20 | 104 | OK | OK | Best | Bad | Bad | Bad |
| | 9 | Residual | 30 | 13 | 13 | 13 | *5 | 74 | OK | OK | Bad | Best | Better | Better |
| | 10 | Residual | 30 | 13 | 13 | 13 | *38 | 107 | Out of range | OK | Best | Bad | Bad | Bad |

From the results of Table 1 the following matters are recognized.

(1) All conventional examples 1-3 were worse at roundness of compressed ball shape, and they do not meet requirements for practical use. The wire strength of conventional example 3 is low, and it does not meet requirements for practical use.

Where, conventional example 1 does not contain La (by indicated * in the Table) and does not satisfy [Ca]<[Eu]+[La]. Conventional example 2 does not contain Eu (by indicated * in the Table) and does not satisfy [Y]<[Ca]+[Eu] and/or [Y]=[Ca]+[Eu]. Conventional example 3 does not contain La and Y (by indicated * in the Table) and does not satisfy [Ca]<[Eu]+[La] and/or [Ca]=[Eu]+[La]. It is considered that these are causes of results for not meeting requirements for practical use.

(2) All embodiment examples 1-11 have good wire strength range, and have aimed characteristics. Moreover, they are all stable at stitch bondability, every sample meets requirements for practical use. All samples have not been observed with whole surface contamination by oxide and shrinkage cavity by scanning electron microscope. It is obtained that formability of molten ball of all samples meet requirements for practical use. Moreover, roundness of every compressed ball is good and every one meets requirements for practical use. Hence, all embodiment examples 1-11 meet requirements for practical use on all evaluation items. Where, all embodiment examples 1-11 satisfy the range of additive elements, which are described in claim 1, and satisfy [Ca]<[Eu]+[La] and/or [Ca]=[Eu]+[La], also [Y]<[Ca]+[Eu] and/or [Y]=[Ca]+[Eu]. It is considered that these are causes of satisfactory results which meet requirements for practical use.
(3) In comparative example 1-10, all samples did not meet requirements for practical use on more than one evaluation item among wire strength, stitch bondability, formability of molten ball and roundness of compressed ball. Where, every comparative example 1-10 did not satisfy the range of additive elements described in claim 1 (by indicated * in the Table), furthermore, by depending on comparative example, it also does not satisfy [Ca]<[Eu]+[La] and/or [Ca]=[Eu]+[La], also [Y]<[Ca]+[Eu] and/or [Y]=[Ca]+[Eu]. Hence, it is considered that these are causes of results not meeting requirements for practical use.

Where, concretely, Mg of comparative example 1 does not satisfy the lower limit of additive range. Consequently, on the roundness of compressed ball it did not meet requirements for practical use. Mg of comparative example 2 does not satisfy the upper limit of additive range. Consequently, on the formability of molten ball it did not meet requirements for practical use. Eu of comparative example 3 does not satisfy the lower limit of additive range, and also does not satisfy [Ca]<[Eu]+[La] and/or [Ca]=[Eu]+[La]. Consequently, on the roundness of compressed ball it did not meet requirements for practical use.

Eu of comparative example 4 does not satisfy the upper limit of additive range. Consequently, on the formability of molten ball it does not meet requirements for practical use. La of comparative example 5 does not satisfy the lower limit of additive range, and also does not satisfy [Ca]<[Eu]+[La] and/or [Ca]=[Eu]+[La]. Consequently, on the roundness of compressed ball shape it did not meet requirements for practical use. La of comparative example 6 does not satisfy the upper limit of additive range. Consequently, on the formability of molten ball it does not meet requirements for practical use. Y of comparative example 7 does not satisfy the lower limit of additive range. Consequently, on the wire strength it does not meet requirements for practical use. Y of comparative example 8 does not satisfy the upper limit of additive range. Consequently, on the stitch bondability and the formability of molten ball it does not meet requirements for practical use. Ca of comparative example 9 does not satisfy the lower limit of additive range. Consequently, on the wire strength it does not meet requirements for practical use. Ca of comparative example 10 does not satisfy the upper limit of additive range and also does not satisfy [Ca]<[Eu]+[La] and/or [Ca]=[Eu]+[La]. Consequently, on the stitch bondability, the formability of molten ball and roundness of compressed ball it does not meet requirements for practical use.

### [Evaluation 2]

Embodiment examples and comparative examples shown in Table 2 are explained. Evaluation 2 was used as same melting method and metal works as in Evaluation 1, and used Au alloy wires for ball bonding with varied composition ratio of additive elements. The evaluation method of Evaluation 2 is same as Evaluation 1.

In the Evaluation 2 effects of using an optional 2 additive elements varied from among 5 elements of Mg. Ca, Eu, Y and La were evaluated (Total 20 combinations). The volume of one of 2 elements is varied out of the lower limit of the standard, near the lower limit within the standard, near the upper limit within the standard and out of the upper limit of the standard. On the contrary, volume of another element is varied out of the upper limit of the standard, near the upper limit within the standard, near the lower limit of the standard, and out of the lower limit of the standard. Moreover, it is defined as embodiment examples, which meet the standard and as comparative examples, which do not meet the standard.

For instance, in embodiment example 1-2 and comparative example 1-2, a combination of 2 elements of Mg and Eu was selected. The range of additive elements is defined as the standard described in claim 1 as 15-50 wt ppm Mg, and 5-20 wt ppm Eu.

Concretely, Mg was varied in order of 10 wt ppm, 18 wt ppm, 42 wt ppm, 58 wt ppm, Eu was varied in order of 28 wt ppm, 18 wt ppm, 8 wt ppm, 2 wt ppm. In Evaluation 2, 2 elements were varied within the standard and out of the standard, and bondability was evaluated as same as Evaluation 1.

In the same manner, in embodiment example 3-4 and comparative example 3-5, Mg and La were selected, in embodiment example 5-6 and comparative example 5-6, Mg and Y were selected, in embodiment example 7-8 and comparative example 7-8, Mg and Ca were selected, in embodiment example 9-10 and comparative example 9-10, Eu and La were selected, in embodiment example 11-12 and comparative example 11-12, Eu and Y were selected, in embodiment example 13-14 and comparative example 13-14, Eu and Ca were selected, in embodiment example 15-16 and comparative example 15-16, La and Y were selected, in embodiment example 17-18 and comparative example 17-18, La and Ca were selected, in embodiment example 19-20 and comparative example 19-20, Y and Ca were selected. Where, each additive elements are defined as standard described in claim 1 as 15-50 wt ppm Mg, 10-30 wt ppm Ca, 5-20 wt ppm Eu, 5-20 wt ppm Y, and 5-20 wt ppm La.

TABLE 2

| | | | Kinds of | | | | | | | | Measurement results | | | |
|---|---|---|---|---|---|---|---|---|---|---|---|---|---|---|
| | | | additive elements | | | | | Calculated results | | | | | | Roundness |
| | | | and its ratio | | | | | (wt ppm) | | | | | Formability | of |
| | | | (wt ppm) | | | | | Total | Ca < | Y < | Wire | Stitch | of | compressed |
| | | Au | Mg | Eu | La | Y | Ca | amount | Eu + La | Eu + Ca | strength | bondabiliy | molten ball | ball |
| Embodiment | 1 | Residual | 18 | 18 | 15 | 13 | 18 | 82 | OK | OK | Better | Better | Good | Good |
| examples | 2 | Residual | 42 | 8 | 15 | 13 | 18 | 96 | OK | OK | Good | Better | Good | Better |
| | 3 | Residual | 18 | 15 | 18 | 13 | 18 | 82 | OK | OK | Better | Better | Good | Good |
| | 4 | Residual | 42 | 15 | 8 | 13 | 18 | 96 | OK | OK | Good | Better | Good | Better |
| | 5 | Residual | 18 | 15 | 15 | 18 | 18 | 84 | OK | OK | Better | Better | Better | Better |
| | 6 | Residual | 42 | 15 | 15 | 8 | 18 | 98 | OK | OK | Good | Better | Good | Better |
| | 7 | Residual | 18 | 15 | 15 | 13 | 22 | 83 | OK | OK | Better | Better | Better | Better |
| | 8 | Residual | 42 | 15 | 15 | 13 | 13 | 98 | OK | OK | Good | Better | Good | Better |
| | 9 | Residual | 30 | 18 | 8 | 13 | 18 | 87 | OK | OK | Better | Better | Good | Better |
| | 10 | Residual | 30 | 8 | 18 | 13 | 18 | 87 | OK | OK | Better | Better | Good | Better |
| | 11 | Residual | 30 | 18 | 15 | 8 | 18 | 89 | OK | OK | Good | Better | Good | Better |
| | 12 | Residual | 30 | 8 | 15 | 18 | 18 | 89 | OK | OK | Better | Better | Good | Good |
| | 13 | Residual | 30 | 18 | 15 | 13 | 13 | 89 | OK | OK | Good | Better | Good | Better |
| | 14 | Residual | 30 | 8 | 15 | 13 | 22 | 88 | OK | OK | Better | Good | Better | Better |
| | 15 | Residual | 30 | 15 | 18 | 8 | 18 | 89 | OK | OK | Good | Better | Better | Better |
| | 16 | Residual | 30 | 15 | 8 | 18 | 18 | 89 | OK | OK | Better | Better | Better | Good |
| | 17 | Residual | 30 | 15 | 18 | 13 | 13 | 89 | OK | OK | Good | Better | Good | Better |
| | 18 | Residual | 30 | 15 | 8 | 13 | 22 | 88 | OK | OK | Better | Better | Better | Good |
| | 19 | Residual | 30 | 15 | 15 | 8 | 28 | 96 | OK | OK | Good | Better | Better | Good |
| | 20 | Residual | 30 | 15 | 15 | 18 | 13 | 91 | OK | OK | Good | Better | Better | Good |
| Comparative | 1 | Residual | *10 | *28 | 15 | 13 | 18 | 84 | OK | OK | Better | Better | Good | Bad |
| examples | 2 | Residual | *58 | *2 | 15 | 13 | 18 | 106 | Out of range | OK | Good | Better | Bad | Good |
| | 3 | Residual | *10 | 15 | *28 | 13 | 18 | 84 | OK | OK | Better | Better | Good | Bad |
| | 4 | Residual | *58 | 15 | *2 | 13 | 18 | 106 | Out of range | OK | Good | Better | Bad | Good |
| | 5 | Residual | *10 | 15 | 15 | *28 | 18 | 86 | OK | OK | Better | Better | Good | Bad |
| | 6 | Residual | *58 | 15 | 15 | *2 | 18 | 108 | OK | OK | Bad | Best | Bad | Good |
| | 7 | Residual | *10 | 15 | 15 | 13 | *38 | 91 | Out of range | OK | Best | Bad | Good | Bad |
| | 8 | Residual | *58 | 15 | 15 | 13 | *5 | 106 | OK | OK | Bad | Best | Bad | Good |
| | 9 | Residual | 30 | *28 | *2 | 13 | 18 | 91 | OK | OK | Good | Better | Good | Bad |
| | 10 | Residual | 30 | *2 | *28 | 13 | 18 | 91 | OK | OK | Good | Better | Good | Bad |
| | 11 | Residual | 30 | *28 | 15 | *2 | 18 | 93 | OK | OK | Bad | Better | Good | Better |
| | 12 | Residual | 30 | *2 | 15 | *28 | 18 | 93 | Out of range | Out of | Good | Better | Good | Bad |
| | | | | | | | | | | range | | | | |
| | 13 | Residual | 30 | *28 | 15 | 13 | *5 | 91 | OK | OK | Bad | Better | Good | Better |
| | 14 | Residual | 30 | *2 | 15 | 13 | *38 | 98 | Out of range | OK | Better | Good | Bad | Bad |
| | 15 | Residual | 30 | 15 | *28 | *2 | 18 | 93 | OK | OK | Bad | Better | Good | Better |
| | 16 | Residual | 30 | 15 | *2 | *28 | 18 | 93 | Out of range | OK | Good | Better | Good | Bad |
| | 17 | Residual | 30 | 15 | *28 | 13 | *5 | 91 | OK | OK | Bad | Better | Good | Better |
| | 18 | Residual | 30 | 15 | *2 | 13 | *38 | 98 | Out of range | OK | Better | Good | Bad | Bad |
| | 19 | Residual | 30 | 15 | 15 | *2 | *38 | 100 | Out of range | OK | Good | Better | Bad | Bad |
| | 20 | Residual | 30 | 15 | 15 | *28 | *5 | 93 | OK | Out of | Bad | Best | Good | Bad |
| | | | | | | | | | | range | | | | |

From the results in Table 2 the followings are recognized.

(1) Embodiment examples 1-20 are all in the good range at wire strength and have obtained aimed characteristics. Moreover, all are stable at stitch bondability, satisfactory results are obtained to meet requirements for practical use. All examples do not have whole contamination of oxides and shrinkage cavities from observation by scanning electron microscopy, satisfactory results are obtained to meet requirements for practical use on formability of molten ball for every example. Moreover, all examples are good at roundness of compressed ball, satisfactory results are obtained to meet requirements for practical use. Hence, it shows that for embodiment examples 1-20 satisfactory results are obtained to meet requirements for practical use at all evaluation items. Where, all embodiment examples 1-20 satisfy the additive range described in claim 1 and also satisfy the equations of [Ca]<[Eu]+[La] and/or [Ca]=[Eu]+[La], also [Y]<[Ca]+[Eu] and/or [Y]=[Ca]+[Eu]. Hence, it is considered that these are causes of results meeting requirements for practical use.

(3) Comparative examples 1-20 do not meet requirements for practical use on more than one evaluation item among wire strength, stitch bondability, formability of molten ball and roundness of compressed ball. Every comparative example does not satisfy the range of additive elements described in claim 1 at 2 elements (by indicated * in the Table) and also does not satisfy [Ca]<[Eu]+[La] and/or [Ca]=[Eu]+[La], also [Y]<[Ca]+[Eu] and/or [Y]=[Ca]+[Eu]. Hence, it is considered that these are causes of results that do not meet requirements for practical use.

Concretely, on comparative example 1, volume of additive Mg does not satisfy the lower limit and volume of additive Eu does not satisfy the upper limit. Consequently, the roundness of compressed ball result does not meet requirements for practical use. On comparative example 2, volume of additive Mg does not satisfy the upper limit and volume of additive Eu does not satisfy the lower limit. Moreover it does not satisfy [Ca]<[Eu]+[La] and/or [Ca]=[Eu]+[La]. Consequently, on the formability of molten ball, the result does not meet requirements for practical use. On comparative example 3, the volume of additive Mg does not satisfy the lower limit and volume of additive La does not satisfy the upper limit. Consequently, the roundness of compressed ball result does not meet requirements for practical use. On comparative example 4, volume of additive Mg does not satisfy the upper limit and volume of additive La does not satisfy the lower limit. Moreover it does not satisfy [Ca]<[Eu]+[La] and/or [Ca]=[Eu]+[La]. Consequently, on the formability of molten ball, the result does not meet requirements for practical use. On comparative example 5, volume of additive Mg does not satisfy the lower limit and volume of additive Y does not satisfy the upper limit. Consequently, the roundness of compressed ball result does not meet requirements for practical use. On comparative example 6, the volume of additive Mg does not satisfy the upper limit and volume of additive Y does not satisfy the lower limit. Consequently, wire strength and formability of molten ball result does not meet requirements for practical use. On comparative example 7, volume of additive Mg does not satisfy the lower limit and volume of additive Ca does not satisfy the upper limit. Moreover it does not satisfy [Ca]<[Eu]+[La] and/or [Ca]=[Eu]+[La]. Consequently, on the stitch bondability and roundness of compressed ball, the result does not meet requirements for practical use. On comparative example 8, volume of additive Mg does not satisfy the upper limit and volume of additive Ca does not satisfy the lower limit. Consequently, on the wire strength and roundness of compressed ball and formability of molten ball, the result does not meet requirements for practical use. On comparative example 9, volume of additive Eu does not satisfy the upper limit and volume of additive La does not satisfy the lower limit. Consequently, on the roundness of compressed ball, the result does not meet requirements for practical use. On comparative example 10, volume of additive Eu does not satisfy the lower limit and volume of additive La does not satisfy the upper limit. Consequently, on the roundness of compressed ball, the result does not meet requirements for practical use. On comparative example 11, volume of additive Eu does not satisfy the upper limit and volume of additive Y does not satisfy the lower limit. Consequently, on the wire strength, the result does not meet requirements for practical use. On comparative example 12, volume of additive Eu does not satisfy the lower limit and volume of additive Y does not satisfy the upper limit. Moreover it does not satisfy [Ca]<[Eu]+[La] and/or [Ca]=[Eu]+[La] and also it does not satisfy [Y]<[Ca]+[Eu] and/or [Y]=[Ca]+[Eu]. Consequently, on the roundness of compressed ball, the result does not meet requirements for practical use. On comparative example 13, volume of additive Eu does not satisfy the upper limit and volume of additive Ca does not satisfy the lower limit. Consequently, on the wire strength, the result does not meet requirements for practical use. On comparative example 14, volume of additive Eu does not satisfy the lower limit and volume of additive Ca does not satisfy the upper limit. Moreover it does not satisfy [Ca]<[Eu]+[La] and/or [Ca]=[Eu]+[La]. Consequently, on the formability of molten ball and roundness of compressed ball, the result does not meet requirements for practical use. On comparative example 15, volume of additive La does not satisfy the upper limit and volume of additive Y does not satisfy the lower limit. Consequently, on the wire strength, the result does not meet requirements for practical use. On comparative example 16, volume of additive La does not satisfy the lower limit and volume of additive Y does not satisfy the upper limit. Moreover it does not satisfy [Ca]<[Eu]+[La] and/or [Ca]=[Eu]+[La]. Consequently, on the roundness of compressed ball, the result does not meet requirements for practical use. On comparative example 17, volume of additive La does not satisfy the upper limit and volume of additive Ca does not satisfy the lower limit. Consequently, on the wire strength, the result does not meet requirements for practical use. On comparative example 18, volume of additive La does not satisfy the lower limit and volume of additive Ca does not satisfy the upper limit. Moreover it does not satisfy [Ca]<[Eu]+[La] and/or [Ca]=[Eu]+[La]. Consequently, on the formability of molten ball and roundness of compressed ball, the result does not meet requirements for practical use. On comparative example 19, volume of additive Y does not satisfy the lower limit and volume of additive Ca does not satisfy the upper limit. Moreover it does not satisfy [Ca]<[Eu]+[La] and/or [Ca]=[Eu]+[La]. Consequently, on the formability of molten ball and roundness of compressed ball, the result does not meet requirements for practical use. On comparative example 20, volume of additive Y does not satisfy the upper limit and volume of additive Ca does not satisfy the lower limit. Moreover it does not satisfy [Y]<[Ca]+[Eu] and/or [Y]=[Ca]+[Eu]. Consequently, on the wire strength and roundness of compressed ball, the result does not meet requirements for practical use.

### POSSIBILITY FOR INDUSTRIAL USE

According to an Au alloy wire for ball bonding of the present invention, an Au alloy comprising the prescribed range of trace additives Ca-Mg-Eu-La-Y has superior effects of wire strength, stitch bondability, roundness of compressed ball and formability of molten ball, and is effective for improving manufacturability of semiconductor equipment. Specifically, attaining wire strength, stitch bondability and roundness of compressed ball at once makes it effective for improving manufacturability of a semiconductor device, such as BGA low temperature package using electroless Au plating, for which it is known that ball bonding is difficult with narrow pitch and high density and stitch bonding is also difficult.

### BRIEF DESCRIPTION OF THE DRAWINGS

FIG. 1 Explanatory schema of bonding method by ball bonding

FIG. 2(a) and (b) are shown shape and size of bonding portion by ball bonding method and stitch bonding method

FIG. 3 Explanatory schema of measuring method of bonding strength of bonding wire

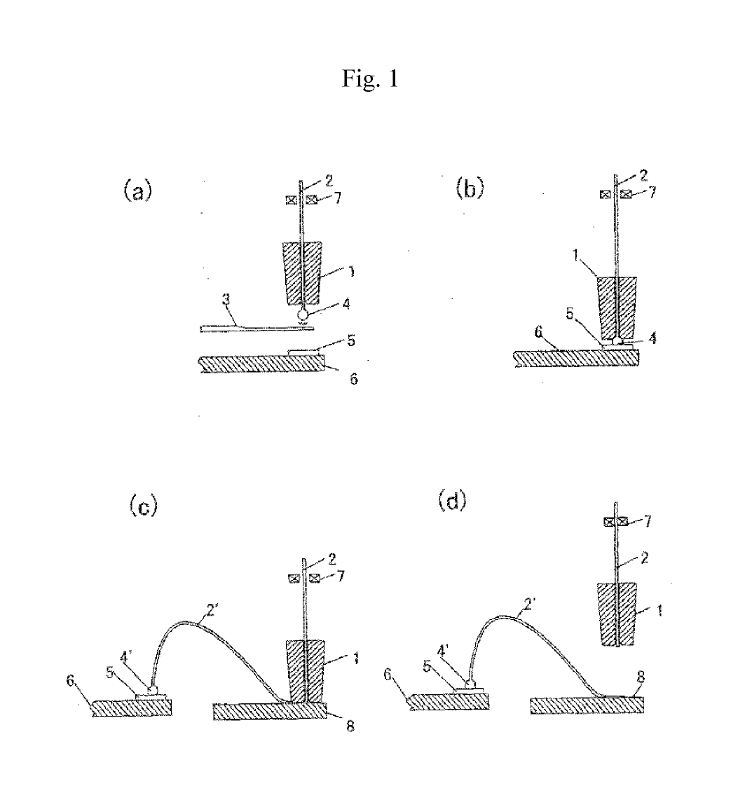

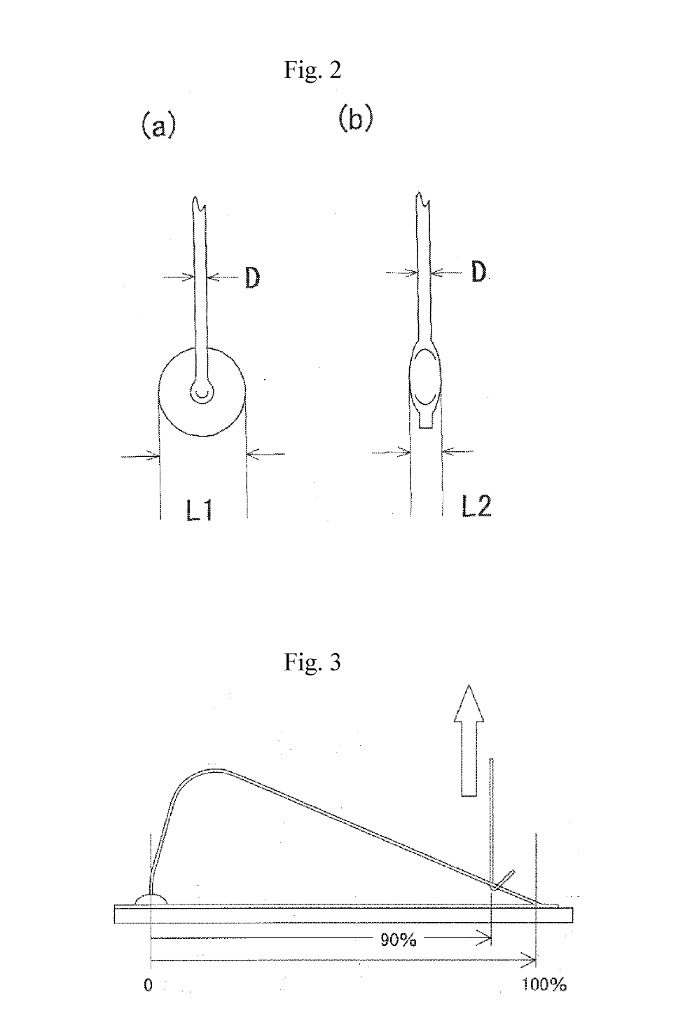

### EXPLANATION OF SYMBOLS

1 Capillary
2 Wire
3 Electrode torch
4 Ball
4′ Compressed ball
5 Al electrode
6 IC Chip
7 Clamper
8 Outer wiring
D Wire diameter
L1 Compressed ball diameter
L2 Compressed width

1. An Au alloy wire for ball bonding comprising: 15-50 wt ppm Mg, 10-30 wt ppm Ca, 5-20 wt ppm Eu, 5-20 wt ppm Y, 5-20 wt ppm La, and residual Au, wherein the Au alloy wire has Au purity of 99.99 wt % or higher.

2. An Au alloy wire for ball bonding comprising: 15-50 wt ppm Mg, 10-30 wt ppm Ca, 5-20 wt ppm Eu, 5-20 wt ppm Y, 5-20 wt ppm La, residual Au, wherein the Au alloy wire has Au purity of 99.98 wt % or higher.

3. The Au alloy wire for ball bonding according to claim 1, wherein the mass of additive Ca is less than the value of the total amount of additive Eu and additive La, and the mass of additive Y is less than the value of the total amount of additive Ca and additive Eu, and the amount of Mg is 20-40 wt ppm.

4. The Au alloy wire for ball bonding according to claim 1, wherein the mass of additive Ca is less than the value of the total amount of additive Eu and additive La, and the amount of Mg is 20-40 wt ppm.

5. The Au alloy wire for ball bonding according to claim 1, wherein the mass of additive Ca is less than the value of the total amount of additive Eu and additive La, and the mass of additive Y is less than the value of the total amount of additive Ca and additive Eu.

6. The Au alloy wire for ball bonding according to claim 1, wherein the mass of additive Ca is less than the value of total amount of additive Eu and additive La.

7. The Au alloy wire for ball bonding according to claim 2, wherein the mass of additive Ca is less than the value of the total amount of additive Eu and additive La, and the mass of additive Y is less than the value of the total amount of additive Ca and additive Eu, and the amount of Mg is 20-40 wt ppm.

8. The Au alloy wire for ball bonding according to claim 2, wherein the mass of additive Ca is less than the value of the total amount of additive Eu and additive La, and the amount of Mg is 20-40 wt ppm.

9. The Au alloy wire for ball bonding according to claim 2, wherein the mass of additive Ca is less than the value of the total amount of additive Eu and additive La, and the mass of additive Y is less than the value of the total amount of additive Ca and additive Eu.

10. The Au alloy wire for ball bonding according to claim 2, wherein the mass of additive Ca is less than the value of the total amount of additive Eu and additive La.

11-12. (canceled)
